(19) United States
(12) Patent Application Publication
(10) Pub. No.: US 2016/0279909 A1
(43) Pub. Date: Sep. 29, 2016

(54) A STORAGE DEVICE

(71) Applicant: DOW GLOBAL TECHNOLOGIES LLC, Misland, MI (US)

(72) Inventors: Maximiliano M. Zanetti, Buenos Aires (AR); Jose Eduardo Ruiz, Sugarland, TX (US); Jorge C. Gomes, Sao Paulo (BR)

(21) Appl. No.: 15/034,067

(22) PCT Filed: Oct. 30, 2014
(86) PCT No.: PCT/US2014/063170

§ 371 Date: May 3, 2016

Related U.S. Application Data
(60) Provisional application No. 61/901,565, filed on Nov. 8, 2013.

(51) Int. Cl. B32B 27/08; B32B 27/18; B65D 88/16; B32B 27/32

(52) U.S. Cl. CPC B32B 27/08; B32B 27/32; B32B 27/18; B65D 88/1606; B32B 2307/558; B32B 2307/72; B32B 2439/00

(57) ABSTRACT

The instant invention provides a storage device. The storage device according to the present invention comprises (a) a N sleeve having a 1st end and a 2nd end, and (b) a protective jacket comprising at least 70% by weight of an ultra-linear low density polyethylene having a density in the range of from 0.900 to 0.910 g/cm³, and a melt index (I₂) in the range of less than 5 g/10 minutes, up to 30% by weight of a low-density polyethylene having a density in the range of from 0.920 to 0.925 g/cm³, and a melt index (I₂) in the range of less than 5 g/10 minutes, and one or more additives.

### FIELD OF INVENTION

The instant invention relates to a storage device.

### BACKGROUND OF THE INVENTION

The use of silo bags for grain storage is generally known. Such silo bags are typically heavy polymeric based tubular devices, approximately between 4 to 12 feet in diameter, and of variable length as required for the amount of materials to be stored, e.g. 60 meters, 75 meters, and 100 meters. They are typically packed using a machine made for the purpose, and sealed on both ends. The bag is often discarded in sections as it is torn off. Such silo bags require little capital investment and can be used as a temporary measure when growth or harvest conditions require more space, or in the alternative, can be used regularly to provide storage facilities.

Despite the efforts in improving the qualities of such silo bags, there is a need for silo bags having improved physical properties such as improved puncture resistance as well as improved dart impact resistance.

### SUMMARY OF THE INVENTION

The instant invention provides a storage device. The storage device according to the present invention comprises (a) a sleeve having a 1st end and a 2nd end, and (b) a protective jacket comprising at least 70% by weight of an ultra-linear low density polyethylene having a density in the range of from 0.900 to 0.910 g/cm³, and a melt index (I₂) in the range of less than 5 g/10 minutes, up to 30% by weight of a low-density polyethylene having a density in the range of from 0.920 to 0.925 g/cm³, and a melt index (I₂) in the range of less than 5 g/10 minutes, and one or more additives.

In one embodiment, the storage device according to present invention comprises a sleeve comprising: (a) at least an external layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one or more additives; (b) at least a core layer comprising at least 70% by weight of a linear low density polyethylene having a density in the range of from 0.917 to 0.930 g/cm³ and a melt index (I₂) in the range of less than 5 g/10 minutes, at least 30% by weight of a low density polyethylene having a density in the range of from 0.920 to 0.925 g/cm³ and a melt index (I₂) in the range of less than 5 g/10 minutes, and optionally one or more additives; and (c) at least an internal layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one more additives.

In another embodiment, the inventive storage device comprises a protective jacket having a thickness in the range of from 50 to 100 μm.

In another embodiment, the inventive storage device, including the sleeve and the protective jacket, has a thickness in the range of from 200 to 500 μm, and is characterized by one or more of the followings: (a) having a puncture resistance, measured according to ASTM D5748 in the range of from 8 to 16 J/m³, (b) a dart impact resistance, measured according to ASTM D1709, in the range of from 1100 to 1600 g.

### DETAILED DESCRIPTION OF THE INVENTION

The instant invention provides a storage device. The storage device according to the present invention comprises (a) a sleeve having a 1st end and a 2nd end, and (b) a protective jacket comprising at least 70% by weight of an ultra-linear low density polyethylene having a density in the range of from 0.900 to 0.910 g/cm³, and a melt index (I₂) in the range of less than 5 g/10 minutes, up to 30% by weight of a low-density polyethylene having a density in the range of from 0.920 to 0.925 g/cm³, and a melt index (I₂) in the range of less than 5 g/10 minutes, and one or more additives.

The sleeve has a 1st end and a 2nd end, and optionally means for closing and/or sealing the 1st end and/or 2nd end. Means for closing and/or sealing include, but are not limited to, any fastener devices including, but not limited to, buckle, hook, clamp, tie, clip, clasp, snap, bolt, bar, lacing, Velcro, pin, nail, rivet, tack, screw, binder, weld, zipper, rope, cable, wire, chain, harness, strap, latch, staple, and latchet.

The sleeve can be made from any materials such polymeric based compositions, e.g. polyethylene, and/or polypropylene. In one embodiment, the sleeve comprises a blend of linear low density polyethylene and low density polyethylene. In one embodiment, the sleeve comprises: (a) at least an external layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one or more additives; (b) at least a core layer comprising at least 70% by weight of a linear low density polyethylene having a density in the range of from 0.917 to 0.930 g/cm³ and a melt index (I₂) in the range of less than 5 g/10 minutes, at least 30% by weight of a low density polyethylene having a density in the range of from 0.920 to 0.925 g/cm³ and a melt index (I₂) in the range of less than 5 g/10 minutes, and optionally one or more additives; and (c) at least an internal layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one more additives.

The various sleeve layers can each further comprise one or more additional additives. Such additives include, but are not limited to, one or more nucleating agents, one or more antistatic agents, one or more color enhancers, one or more dyes, one or more lubricants, one or more fillers, one or more pigments, one or more primary antioxidants, one or more secondary antioxidants, one or more processing aids, one or more UV stabilizers, and/or combinations thereof. Each layer may comprise any amounts of such additives. Each sleeve layer may comprise from about 0 to about 10 percent by the combined weight of such additives, based on the total weight of each such sleeve layer.

The sleeve can be monolayer structure or multilayer structure. In one embodiment, the sleeve has three layers or more. The sleeve can have additional layers to provide additional structural integrity and/or barrier properties. Such additional layers can comprise polymeric materials including, but not limited to, polyolefins such as polyethylene and polypropylene, paper, metal, and the like. The sleeve can be made via any conventional method known to a person of ordinary skill in art. Such methods include, but are not limited to, blown film process.

The sleeve can have any length suitable for various storage applications. The sleeve, for example can have a length in the range of less than 500 m, for example, less than 300 m, or in the alternative, less than 200 m, or in the alternative, less than 100 meters, or in the alternative from 40 to 60 m. The sleeve can have any diameter suitable for various storage applications. The sleeve can have a diameter in the range of from less than 5 m, for example, less than 3 m, or in the alternative, less than 2 m, or in the alternative, less than 1 meter. The sleeve can have any cross-sectional periphery including, but not limited to, elliptical, circular, semicircular, rectangular, and/or triangular. The sleeve can have a uniform diameter along the length of the sleeve, or in the alternative, the sleeve can be tapered from one end to the other end. The sleeve can have a tubular shape, an oval-shaped, a cylindrical shape, a cone shape, and/or a conical shape. The sleeve can further be compartmentalized into 2 or more sections, and each section can be maintained separate from each other via different means for closing and/or sealing including, but not limited, to any fastener devices such as buckle, hook, clamp, tie, clip, clasp, snap, bolt, bar, lacing, Velcro, pin, nail, rivet, tack, screw, binder, weld, zipper, rope, cable, wire, chain, harness, strap, latch, staple, and latchet.

The inventive storage device further comprises a protective jacket. The protective jacket has a 1st end and a 2nd end, and optionally means for closing and/or sealing the 1st end and/or 2nd end. Means for closing and/or sealing include, but are not limited to any fastener devices including, but not limited to, buckle, hook, clamp, tie, clip, clasp, snap, bolt, bar, lacing, Velcro, pin, nail, rivet, tack, screw, binder, weld, zipper, rope, cable, wire, chain, harness, strap, latch, staple, and latchet.

The protective jacket comprises an ultra-linear low density polyethylene, a low-density polyethylene, and one or more additives. In one embodiment the protective jacket comprises at least 70%, for example from 70 to 95%, by weight of an ultra-linear low density polyethylene having a density in the range of from 0.900 to 0.910 g/cm³, and a melt index (I₂) in the range of less than 5, for example from 0.1 to 4, g/10 minutes, up to 30%, for example from 5 to 30%, by weight of a low-density polyethylene having a density in the range of from 0.920 to 0.925 g/cm³, and a melt index (I₂) in the range of less than 5 , for example from 0.1 to 4, g/10 minutes, and one or more additives. Such additives include, but are not limited to, one or more nucleating agents, one or more antistatic agents, one or more color enhancers, one or more dyes, one or more lubricants, one or more fillers, one or more pigments, one or more primary antioxidants, one or more secondary antioxidants, one or more processing aids, one or more UV stabilizers, and/or combinations thereof. Each layer may comprise any amounts of such additives. Each protective jacket layer may comprise from about 0 to about 10 percent by the combined weight of such additives, based on the total weight of each such protective jacket layer.

The protective jacket can be a monolayer structure or a multilayer structure. In one embodiment, the protective jacket has two layers or more. The protective jacket can have additional layers to provide additional structural integrity and/or barrier properties. Such additional layers can comprise polymeric materials including, but not limited to, polyolefins such as polyethylene and/or polypropylene, paper, metal, and the like. The protective jacket can be made via any conventional method know to a person of ordinary skill in art. Such methods include, but are not limited, blown film process.

The protective jacket can have any length suitable for various storage applications. Typically, the protective jacket has a complementary size to the sleeve. The protective jacket, for example can have a length in the range of less than 500 m, for example, less than 300 m, or in the alternative, less than 200 m, or in the alternative, less than 100 meters, or in the alternative from 40 to 60 m. The protective jacket can have any diameter suitable for various storage applications. The protective jacket can have a diameter in the range of from less than 5 m, for example, less than 3 m, or in the alternative, less than 2 m, or in the alternative, less than 1 meter. The protective jacket can have any cross-sectional periphery including, but not limited to, elliptical, circular, semicircular, rectangular, and/or triangular. The protective jacket can have a uniform diameter along the length of the sleeve, or in the alternative, the protective jacket can be tapered from one end to the other end. The protective jacket can have a tubular shape, an oval-shaped, a cylindrical shape, a cone shape, and/or a conical shape. The protective jacket can further be compartmentalized into 2 or more sections, and each section can be maintained separate from each other via different means for closing and/or sealing including, but not limited, to any fastener devices such as buckle, hook, clamp, tie, clip, clasp, snap, bolt, bar, lacing, Velcro, pin, nail, rivet, tack, screw, binder, weld, zipper, rope, cable, wire, chain, harness, strap, latch, staple, and latchet.

The protective jacket can have any thickness, for example, the protective jacket can have a thickness in the range of from 50 to 100 μm.

The inventive storage device including the sleeve and the protective jacket can have a thickness in the range of up to 500 μm, for example from 200 to 400 μm, or in the alternative from 225 to 300 μm, and can be characterized by one or more of the followings: (a) having a puncture resistance, measured according to ASTM D5748 , in the range of from 8 to 16 J/m³, and/or (b) a dart impact resistance, measured according to ASTM D1709 in the range of from 1100 to 1600 g.

In one embodiment, the protective jacket and the sleeve have a complimentary shape and/or size so long as the complimentary shape and/or size facilitate for the coverage of the exposed portion of the sleeve.

The sleeve and the protective jacket can be assembled into the inventive storage device as two permanently unified components, or in the alternative, the sleeve and the protective jacket can be assembled into a storage device as separable components. Alternatively, the sleeve and the protective jacket can be made as a one multilayer structure, for example via blown film process. In one embodiment, the sleeve and protective jacket are assembled into a storage device, and then filled with target products. In another alternative embodiment the sleeve is filled with target products, and then covered by the protective jacket.

The storage device can be filled by any means known to a person of ordinary skill in the art. For example, the target product can be filled into the storage device via a mechanical device such as a grain bagger.

In one embodiment, a storage device comprising a sleeve and a protective jacket, each having a 1st and 2nd end, is provided, wherein one end, e.g. 2nd end of each sleeve and protective jacket, is sealed, and the mechanical device advances the target products into the storage device via the open end, e.g. 1^{st} end. As a consequence, the storage device will be gradually filled with target products, and subsequently, the open end, e.g. 1st end of each the sleeve and the protective jacket, will the sealed.

### EXAMPLES

The following examples illustrate the present invention but are not intended to limit the scope of the invention. The examples of the instant invention demonstrate that the inventive storage devices provide improved physical properties.

### Formulation Components:

Linear low density polyethylene 1 (LLDPE 1) is an ethylene octane copolymer having a density of approximately 0.919 g/cm³ and a melt index (I₂) of approximately 0.95 g/10 minutes, which is commercially available from The Dow Chemical Company under the trade name DOWLEX™TG 2085B.

Low density polyethylene 1 (LDPE 1) is an ethylene polymer having a density of approximately 0.921 g/cm³ and a melt index (I₂) of approximately 0.25 g/10 minutes, which is commercially available from The Dow Chemical Company under the trade name DOW™ LDPE 132i.

Low density polyethylene 2 (LDPE 2) is an ethylene polymer having a density of approximately 0.921 g/cm³ and a melt index (I₂) of approximately 0.30 g/10 minutes, which is commercially available from The Dow Chemical Company under the trade name DOW™ LDPE 204M.

Ultra Low density polyethylene 1 (ULDPE 1) is an ethylene polymer having a density of approximately 0.905 g/cm³ and a melt index (I₂) of approximately 0.80 g/10 minutes, which is commercially available from The Dow Chemical Company under the trade name ATTANE™ 4203G.

Comparative Example 1 is a multilayer structure prepared based on the formulation components reported in Table 1 via blown film process according to the conditions reported in Table 2B. Comparative Example 1 was tested for its physical properties, and the results are reported in Tables 2 A and 3.

Inventive Example 1 comprises a sleeve and a protective jacket. The sleeve is a multilayer structure prepared based on the formulation components reported in Table 1 via blown film process according to the conditions reported in Table 2B. The protective jacket is also a multilayer structure prepared based on the formulation components reported in Table 1 via blown film process according to the conditions reported in Table 2C. Inventive Example 1 was tested for its physical properties, and the results are reported in Tables 2A and 3.

TABLE 1

| | | | Inventive |
|---|---|---|---|
| | | Inventive | Example 1 |
| | | Example 1 | (Protective |
| | Comparative | (Sleeve | Jacket |
| | Example 1 | Component) | Component) |
| Layer A | 41.5% by weight of | 41.5% by weight | 25% by weight |
| (External | LDPE2, 50% by | of LDPE2, 50% by | of LDPE1, 70% |
| Layer) | weight of LLDPE1, | weight of LLDPE1, | by weight of |
| | and 8.5% by weight | and 8.5% by weight | ULDPE1, and |
| | of additive package | of additive package | 5% by weight of |
| | | | additive package |
| Layer B | 26% by weight of | 26% by weight of | 25% by weight of |
| | LDPE2, 65% by | LDPE2, 65% by | LDPE1, 70% |
| | weight of LLDPE1, | weight of LLDPE1, | by weight of |
| | and 9% by weight | and 9% by weight | ULDPE1, and |
| | of additive package | of additive package | 5% by weight of |
| | | | additive package |
| Layer C | 15% by weight of | 15% by weight of | 25% by weight of |
| | LDPE2, 78% by | LDPE2, 78% by | LDPE1, 70% |
| | weight of LLDPE1, | weight of LLDPE1, | by weight of |
| | and 7% by weight | and 7% by weight | ULDPE1, and |
| | of additive package | of additive package | 5% by weight of |
| | | | additive package |
| Layer D | 23% by weight of | 23% by weight of | 25% by weight of |
| | LDPE2, and 77% | LDPE2, and 77% | LDPE1, 70% |
| | by weight of | by weight of | by weight of |
| | LLDPE1 | LLDPE1 | ULDPE1, and |
| | | | 5% by weight of |
| | | | additive package |
| Layer E | 27% by weight of | 27% by weight of | 25% by weight of |
| (Internal | LDPE2, 65% by | LDPE2, 65% by | LDPE1, 70% |
| Layer) | weight of LLDPE1, | weight of LLDPE1, | by weight of |
| | and 8% by weight | and 8% by weight | ULDPE1, and |
| | of additive package | of additive package | 5% by weight of |
| | | | additive package |

TABLE 2A

| | | | Inventive |
|---|---|---|---|
| | | Inventive | Example 1 |
| | | Example 1 | (Protective |
| | Comparative | (Sleeve | Jacket |
| | Example 1 | Component) | Component) |
| | (Layer | (Layer | (Layer |
| | Thickness | Thickness | Thickness |
| | Percentage) | Percentage) | Percentage) |
| Total structure thickness | 230 μm | 230 μm | 70 μm |
| Layer A (External Layer) | 30 | 30 | 30 |
| Layer B | 13 | 13 | 15 |
| Layer C | 14 | 14 | 10 |
| Layer D | 13 | 13 | 15 |
| Layer E (Internal Layer) | 30 | 30 | 30 |

TABLE 2B

| | Layer A | | | | Layer E |
|---|---|---|---|---|---|
| | (External) | Layer B | Layer C | Layer D | (Internal) |
| Extruder Temperature | 170-195-210- | 170-195-210- | 175-205-220- | 170-195-210- | 170-195-210- |
| profile (° C.) | 225-220 | 225-220 | 240-230 | 225-220 | 225-220 |
| Melt Temp (° C.) | 205 | 212 | 210 | 211 | 215 |
| Melt Pressure (Bar) | 304 | 223 | 218 | 281 | 387 |
| Feeding (Kg/h) | 7.5 | 3.25 | 3.5 | 3.25 | 7.5 |
| Screw speed (rpm) | 97 | 82 | 70 | 84 | 100 |
| Motor loading (A) | 6.6 | 3.4 | 3.2 | 3.7 | 6.7 |

| | |
|---|---|
| Die gap (mm) | 2.2 |
| Die Temp (° C.) | 220 |
| Air Temp (° C.) | 10 |
| Blow up ratio (BUR) | 2.2 |
| Lay flat (mm) | 205 |
| Filter pack | 40/70/40 |

TABLE 2C

| | Layer A | | | | Layer E |
|---|---|---|---|---|---|
| | (External) | Layer B | Layer C | Layer D | (Internal) |
| Extruder Temperature | 190-200-225- | 190-200-225- | 190-200-225- | 190-200-225- | 190-200-225- |
| profile (° C.) | 235-235 | 235-235 | 235-235 | 235-235 | 235-235 |
| Melt Temp (° C.) | 206 | 211 | 206 | 210 | 226 |
| Melt Pressure (Bar) | 182 | 147 | 142 | 175 | 227 |
| Feeding (Kg/h) | 3 | 1.5 | 1 | 1.5 | 3 |
| Screw speed (rpm) | 36 | 34 | 26 | 34 | 39 |
| Motor loading (A) | 4.5 | 2.9 | 2.7 | 2.8 | 4.3 |

| | |
|---|---|
| Die gap (mm) | 1.8 |
| Die Temp (° C.) | 235 |
| Air Temp (° C.) | 12 |
| Blow up ratio (BUR) | 2.2 |
| Lay flat (mm) | 205 |
| Filter pack | 40/70/40 |

TABLE 3

| | | Inventive Example 1 |
|---|---|---|
| | Comparative | (Sleeve + |
| | Example 1 | Protective Jacket) |
| Thickness | 230 μm | 300 μm |
| STD Puncture Resistance (N) | 184.9 | 361.8 |
| Average Energy to Break (J) | 10.24 | 25.20 |
| Std Energy to Break (J) | 0.65 | 1.46 |
| Average Puncture Resistance (J/m³) | 5.5 | 10.3 |
| Std Puncture Resistance (J/Cm³) | 0.32 | 0.60 |
| Dart drop impact Average weight (g) | 1032.5 | 1380.0 |
| Std Weight (g) | 45 | 45 |
| Dart test observation | Breaks all | Did not break at |
| | the time | anytime |

### Test Methods

Test methods include the following:

### Melt Index

Melt index I₂ is measured in accordance to ASTM D-1238 at 190° C. and at 2.16 kg load, and reported in g/10 min.

### Density

Samples for density measurement were prepared according to ASTM D4703. Measurements were made within one hour of sample pressing using ASTM D792, Method B, and reported in g/cm³.

### Dart Impact Strength

Dart impact strength was measured according to ASTM D-1709, Method A.

### Puncture Strength

Puncture strength is measured on an Instron Model 4201 with Sintech Testworks Software Version 3.10. The specimen size is 6″×6″ and 4 measurements are made to determine an average puncture value. The film is conditioned for 40 hours after film production and at least 24 hours in an ASTM controlled laboratory. A 100 lb load cell is used with a round specimen holder 12.56″ square. The puncture probe is a ½″ diameter polished stainless steel ball with a 7.5″ maximum travel length. There is no gauge length; the probe is as close as possible to, but not touching, the specimen. The crosshead speed used is 10″/minute. The thickness is measured in the middle of the specimen. The thickness of the film, the distance the crosshead traveled, and the peak load are used to determine the puncture by the software. The puncture probe is cleaned using a “Kim-wipe” after each specimen.

The present invention may be embodied in other forms without departing from the spirit and the essential attributes thereof, and, accordingly, reference should be made to the appended claims, rather than to the foregoing specification, as indicating the scope of the invention.

We claim:

1. A storage device comprising:
a sleeve having a 1st end and a 2nd end, and
a protective jacket comprising at least 70% by weight of an ultra-linear low density polyethylene having a density in the range of from 0.900 to 0.910 g/cm³, and a melt index (I₂) in the range of less than 5 g/10 minutes, up to 30% by weight of a low-density polyethylene having a density in the range of from 0.920 to 0.925 g/cm³, and a melt index (I₂) in the range of less than 5 g/10 minutes, and one or more additives.

2. The storage device according to claim 1, wherein said slave comprises: (a) at least an external layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one or more additives; (b) at least a core layer comprising at least 70% by weight of a linear low density polyethylene having a density in the range of from 0.917 to 0.930 g/cm³ and a melt index (I₂) in the range of less than 5 g/10 minutes, at least 30% by weight of a low density polyethylene having a density in the range of from 0.920 to 0.925 g/cm³ and a melt index (I₂) in the range of less than 5 g/10 minutes, and optionally one or more additives; and (c) at least an internal layer comprising at least 70% by weight of a linear low density polyethylene having a density in the range of from 0.917 to 0.930 g/cm³ and a melt index (I₂) in the range of less than 5 g/10 minutes, up to 30% by weight of a low density polyethylene having a density in the range of from 0.920 to 0.925 g/cm³ and a melt index (I₂) in the range of less than 5 g/10 minutes, and one more additives.

3. The storage device according to claim 1, wherein said protective jacket has a thickness in the range of from 50 to 100 μm.

4. The storage device according to claim 1, wherein said storage device has a thickness in the range of from 200 to 500 μm, and is characterized by one or more of the followings: (a) having a puncture resistance, measured according to ASTM D5748, in the range of from 8 to 16 J/m³, (b) a dart impact resistance, measured according to ASTM D1709, in the range of from 1100 to 1600 g.
